(19) United States
(12) Patent Application Publication
(10) Pub. No.: US 2004/0060615 A1
(43) Pub. Date: Apr. 1, 2004

(54) Apparatus for guiding saws

(76) Inventor: David J. Coambs, Rimbey (CA)

Correspondence Address: David J. Heller, c/o Ridout & Maybee LLP, Suite 2400, One Queen Street East, Toronto, ON, M5C 3B1, CA

(21) Appl. No.: 10/260,553

(22) Filed: Oct. 1, 2002

(51) Int. Cl. B27M 1/08; B27M 3/00; B27C 9/00

(52) U.S. Cl. 144/372

(57) ABSTRACT

A three sided jig is provided for cutting logs or timber for joints, particularly dovetail joints. Also provided is a slide for use with a chainsaw and a jig.

### FIELD OF THE INVENTION

This invention relates to apparatus for guiding saws. The invention also relates to apparatus for facilitating the cutting of a dovetail, and to methods of cutting dovetails.

### BACKGROUND OF THE INVENTION

Dovetails can be used to join two pieces of wood together, usually at 90 degree angles. When the wood is joined together, the result is an easy to assemble, durable, eye-pleasing joint. Historically, these joints were cut by craftsmen, at a time when labor was much less expensive. Cuts were laid out by hand, and cut with a hand saw. Modern technology has greatly facilitated the cutting of dovetail joints with the use of jigs, templates, special dovetail router bits, power tools, etc. Dovetail joints are thus common in cabinetry, as they can be readily cut with jigs that can be fixed to router tables or table saws. Single dovetails have a single slope per face, while on compound dovetails the joining faces are each sloped in two directions.

Buildings built of hewn logs are traditional in many parts of the world, and are experiencing a revival in North America. In such buildings, logs are laid one upon the other in courses, and may comprise both the wall structure and the interior and exterior finish to the building. In view of the ease of assembly, durability, tight joint formed, and esthetic value, dovetails joints should be ideal for log construction.

However, dovetail joints are not used to any great extent in construction techniques because dovetail joints are difficult to accurately cut. Due to the tight tolerance requirements, errors in fabrication, i.e. not keeping within the required tolerances, can make it difficult to create a tight dovetail joint.

Great Northern Dovetailors (Darby, Mont., USA) sells jigs for cutting sized and squared timber. The jig comprises two square plates from which project two dovetail shaped plates. Four wing nuts tighten the square plates onto the sized and squared timber, and the chainsaw is guided along the dovetail shaped plates. This jig requires the assembly of several pieces: an inner jig section, and outer jig section, four bolts and four nuts. The assembly tends to flex with the torque of the saw while in use, likely because it is not secured directly to the timber. This is particularly problematic when cutting a half or starter timber. The assembly is difficult to line up, and it cannot be used on a round (non-squared) log.

Great Northern Dovetailors teaches the use of rollers on a chainsaw, which hold the bar roughly five eighths of an inch from the guide bars. Unfortunately, this allows for a “porpoising” or “swimming action” when cutting the wood.

### SUMMARY OF THE INVENTION

The invention teaches a jig having (a) a substantially planar end section having an outer portion and an inner portion, the inner portion located opposite the outer portion; (b) a substantially planar outer side section having a first outer edge, a second outer edge opposite the first outer edge, a third outer edge, and a fourth outer edge opposite the third outer edge, wherein the outer side section is fixed to the outer portion of the end section at the fourth outer edge, and the outer side section is substantially perpendicular to the end section; (c) a substantially planar inner side section having a first inner edge, a second inner edge opposite the first inner edge, a third inner edge, and a fourth inner edge opposite the third inner edge, wherein the inner side section is fixed to the inner portion of the end section at the fourth inner edge, and the inner side section is substantially perpendicular to the end section; (d) a first outer guide fixed to and extending along the first outer edge; (e) a second outer guide fixed to and extending along the second outer edge; (f) a shoulder outer guide fixed to and extending along the third outer edge; (g) a first inner guide fixed to and extending along the first inner edge; (h) a second inner guide fixed to and extending along the second inner edge; and (i) a shoulder inner guide fixed to and extending along the third inner edge.

In an embodiment, the inner side section and the outer side section are quadrilateral. The third inner edge may be parallel to the fourth inner edge and the third outer edge may be parallel to the fourth outer edge. The first inner edge may be parallel to the second inner edge and the first outer edge may be parallel to the second outer edge. The first inner guide, the second inner guide, the first outer guide, and the second outer guide may be straight. The first inner guide and the second inner guide may each be fixed at an acute angle in relation to the fourth inner edge, and first outer guide and the second outer guide may each be fixed at an acute angle in relation to the fourth outer edge. The distance between the first inner guide and the second inner guide is greater than the distance between the first outer guide and the second outer guide.

The jig may have an end hole in the end section. The end hole may be centered on the end section. The jig may have a side hole in at least one of the inner side section and the outer side section. The side hole may be on a midline between the first outer guide and the second outer guide and/or on a midline between the first inner guide and the second inner guide.

In an embodiment, angles at an intersection of the second inner guide in relation to the fourth inner edge, at an intersection of the first inner guide in relation to the fourth inner edge, at an intersection of the second outer guide and the fourth outer edge, at an intersection of first outer guide in relation to the fourth outer edge, at an intersection of the second inner guide in relation to the shoulder guide, at an intersection of the first inner guide in relation to the shoulder guide, at an intersection of the second outer guide in relation to shoulder guide, at an intersection of the first outer guide in relation to the shoulder guide, at an intersection of the top edge in relation to the fourth inner edge, at an intersection of the bottom edge in relation to the fourth inner edge, at an intersection of the top edge in relation to the fourth outer edge, and at an intersection of the bottom edge in relation to the fourth outer edge, are all between 75 degrees and 86 degrees, all stated angles are the same, and said jig is configured such that third outer edge is shorter than said fourth outer edge, said third inner edge is shorter than said fourth inner edge, and said fourth outer edge is shorter than said fourth inner edge.

The invention also teaches a slide for guiding a chainsaw comprising a block having a chainsaw side and an outer side, an attachment channel through the block and a slot running perpendicular to the slide channel, the slot configured to receive a jig guide, and a spacer portion on the chain saw side.

The jig guide may be a guide of the jig of the invention. The invention also teaches, in combination, a slide of the invention and a chainsaw. The invention also teaches, in combination, a slide of the invention a jig. The invention also teaches, in combination, a slide of the invention and a jig of the invention.

The invention further teaches a method of cutting a joint on a length of timber comprising: (a) cutting a timber end of the timber so that it is substantially same width as a distance between the outer shoulder guide and the inner shoulder guide of the jig of the invention; (b) cutting the timber end to form an end face perpendicular to the length of the timber; (c) releasably securing the jig on the timber so that the end section is substantially flat against the end face and so that the end section is substantially centered on the timber end; and (d) cutting the timber end along the first inner guide and the first outer guide, cutting the timber end along the second inner guide and the second outer guide and, cutting the timber end along the inner shoulder guide and the outer shoulder guide.

The invention further teaches a method of cutting a joint on a length of timber comprising: (a) cutting a timber end of the timber so that it is substantially same width as a distance between the outer shoulder guide and the inner shoulder guide of the jig of the invention; (b) marking a timber line parallel to the length of timber; (c) releasably securing the jig on the timber so that a midline of the outer side section and a midline of the inner side section is substantially parallel to the timber line, the midline extending substantially perpendicular to the end section; and (d) cutting the timber end along the first inner guide and the first outer guide, cutting the timber end along the second inner guide and the second outer guide and, cutting the timber end along the inner shoulder guide and the outer shoulder guide.

The invention further teaches a jig comprising (a) an end panel; (b) two side panels attached at opposite sides of the end panel, each the side panel perpendicular to the end panel; (c) shoulder guides attached to each the side panel at a portion of the side panels opposite the end panel, the shoulder guides extending beyond the side panels; and (d) joint guides attached to each side panel, the joint guides running between the end panel and the shoulder guides.

### BRIEF DESCRIPTION OF THE DRAWINGS

The invention will now be described, by way of example only, with reference to the accompanying drawings, in which:

FIG. 1 is a perspective view of a jig of the present invention;

FIG. 2 is a front elevation view of the jig of FIG. 1;

FIG. 3 is a elevation view of the “outer” side of the jig of FIG. 1;

FIG. 4 is an elevation view of the “inner” side of the jig of FIG. 1;

FIG. 5 is a side perspective view of the jig of FIG. 1 on a log end;

FIG. 6 is a end view of FIG. 5;

FIG. 7 is a perspective view of the outer side of a slide of the invention;

FIG. 8 is a perspective view of the inner side of a slide of the invention;

FIG. 9 is a perspective view of the slides of FIGS. 7 and 8 in use with the jig of FIG. 1 and a chainsaw.

### DESCRIPTION OF THE PREFERRED EMBODIMENTS

The present inventor has developed a jig that simplifies the process, and increases the speed and accuracy of cutting joints, particularly interlocking compound dovetail joints, on timbers for use in log building and other construction.

The device, which attaches to a timber or log, provides guidance to a saw, such as a chainsaw, to allow uniform and accurate removal of wood to be carried out on each timber. The invention allows an individual to repeatedly cut precise joints without any knowledge of the math required to make the precision cuts. Furthermore, it allows an individual to cut precise joints on a rough hewn log, in addition to a squared timber.

The device is removed and attached to the log or timber as a single piece. It does not flex with the torque of the saw. It is easy to line up, and it can be used with either square timbers or round logs.

The invention also provides slides for guiding a chainsaw along a jig guide, which are much more accurate than the rollers used in the prior art. The slides hold the chainsaw bar much closer to the jig guides. The slides also provide a larger contact area and a contact area secured on both sides of the chainsaw bar, thus preventing the “porpoising” or swimming action experienced with chainsaw rollers of the prior art. Furthermore, the slides of the present invention do not shift when being used to cut a half or starter log.

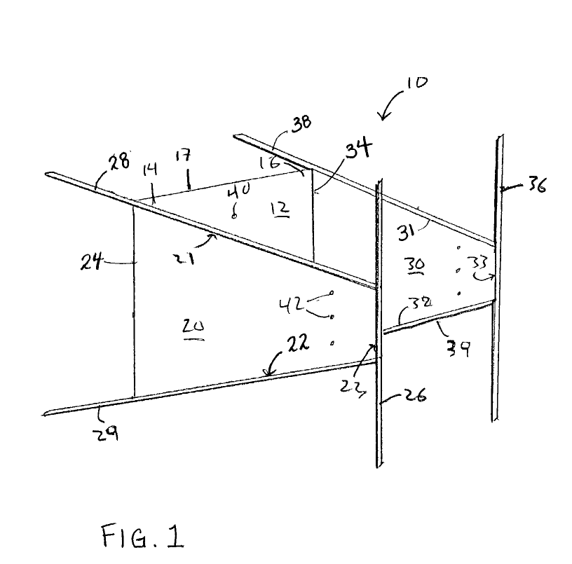

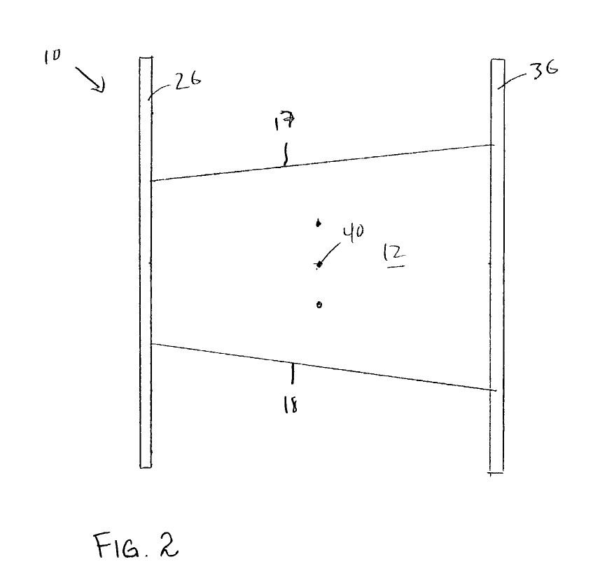

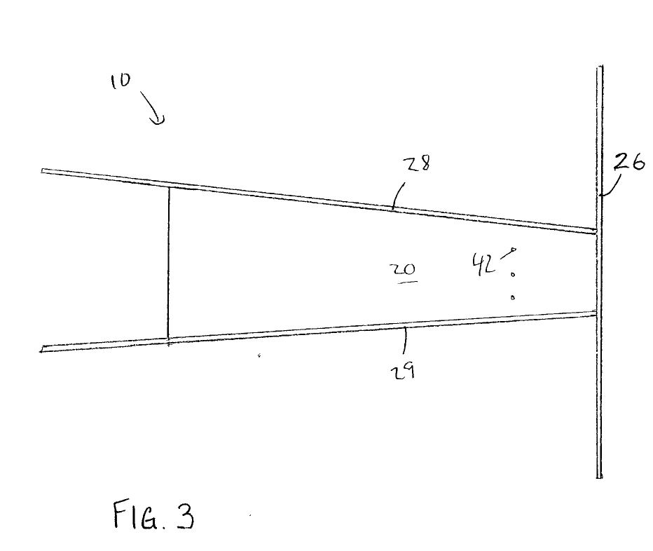

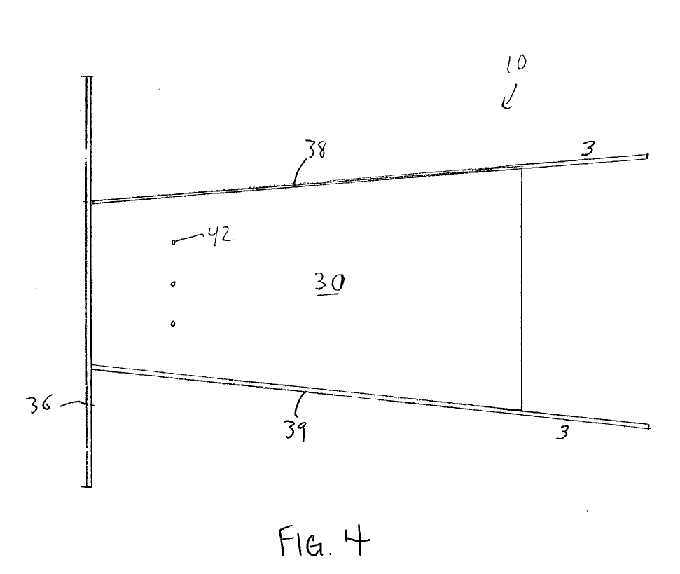

The invention will now be described with reference to the figures. FIG. 1 shows a perspective view of the jig 10. FIG. 2 a front view showing the rear section 12 and shoulder guides 26, 36 of the jig 10. FIGS. 3 and 4 show side views showing the side sections 20 and 30 of the jig 10.

The jig has a substantially planar end section 12 having an outer portion 20 and an inner portion 30. A substantially planar outer side section 20 has a first outer edge 21, a second outer edge 22 opposite the first outer edge, a third outer edge 23, and a fourth outer edge 24 opposite the third outer edge. The outer side section 20 is fixed to the outer portion 14 of the end section 12 at the fourth outer edge 24. The outer side section 20 is substantially perpendicular to the end section 12.

A substantially planar inner side section 30 has a first inner edge 31, a second inner edge 32 opposite the first inner edge 31, a third inner edge 33, and a fourth inner edge 34 opposite the third inner edge 33. The inner side section 30 is fixed to the inner portion 16 of the end section 12 at the fourth inner edge 34. The inner side section 30 is substantially perpendicular to the end section 12.

It will be appreciated that, in other embodiments, the end section 12 can extend beyond the side sections 20 and/or 30. While the end section 12 and side sections 23, 30 are depicted as panels, It will also be appreciated that, in other embodiments, the end and/or side section could be made otherwise, for example, from a strong grill material or as metal bars welded together, so long as the overall structure and function is achieved. It will further be appreciated that, while the invention is shown is a preferred embodiment for facilitating the creation of a compound dovetail joint, it can be readily modified by those skilled in that art to facilitate the creation of other joiner cuts.

A first outer guide 28 is fixed to and extends along the first outer edge 21. A second outer guide 29 is fixed to and extends along the second outer edge 22. A shoulder outer guide 26 is fixed to and extends along the third outer edge 23.

A first inner guide 38 is fixed to and extends along the first inner edge 21. A second inner guide 29 is fixed to and extends along the second inner edge 32. A shoulder inner guide 36 is fixed to and extends along the third inner edge 33.

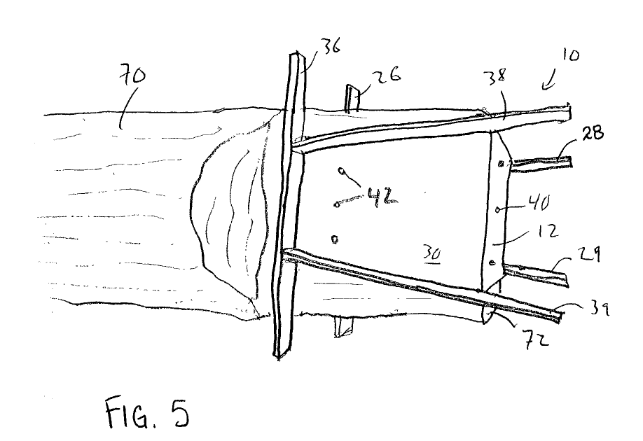

As shown in FIG. 6, first outer guide 28, second outer guide 29, first inner guide 38 and second inner guide 39 are attached at an angle (i.e. not perpendicular in relation to their corresponding side sections. Thus, first outer guide 28 is on the same plane as first inner guide 38 and second outer guide 29 is on the same plane as second inner guide 39, to facilitate guiding the chainsaw along these pairs of guides.

In the embodiment shown, the inner side section and the outer side section are quadrilaterals. However, it will be appreciated that other shapes may be used in certain circumstances, for esthetic or joining purposes.

In the embodiment shown, the third inner edge 33 is parallel to the fourth inner edge 34 and the third outer edge 23 is parallel to the fourth outer edge 24. In other embodiments (not shown), the first inner edge 31 is parallel to the second inner edge 32 and the first outer edge 21 is parallel to the second outer edge 22.

For a dovetail joint, in the embodiment shown, the jig is configured such that the third outer edge 23 is shorter than the fourth outer edge 24, the third inner edge 33 is shorter than the fourth inner edge 34, and the fourth outer edge 24 is shorter than the fourth inner edge 34.

In the embodiment shown, the first inner guide 38 and the second inner guide 39 are each fixed at an acute angle in relation to the fourth inner edge 34, and the first outer guide 28 and the second outer guide 29 are each fixed at an acute angle in relation to the fourth outer edge 24. Preferably, for a compound dovetail joint, these angles are between 75 degrees and 86 degrees at the intersection of the second inner guide 39 in relation to the fourth inner edge 34, and between 75 degrees and 86 degrees at the intersection of the first inner guide 38 in relation to the fourth inner edge 34. A range of between 75 degrees and 86 degrees at the intersection of the second outer guide 29 and the fourth outer edge 24, between 75 degrees and 86 degrees at the intersection of first outer guide 28 in relation to the fourth outer edge 24. Further, for a compound dovetail joint, the angles are between 75 degrees and 86 degrees at the intersection of the second inner guide 39 in relation to the shoulder guide 36, between 75 degrees and 86 degrees at the intersection of the first inner guide 38 in relation to the shoulder guide 36, between 75 degrees and 86 degrees at the intersection of the second outer guide 29 in relation to shoulder guide 26, between 75 degrees and 86 degrees at the intersection of the first outer guide 28 in relation to the shoulder guide 26. Furthermore, the angles are between 75 degrees and 86 degrees at the intersection of the top edge 17 in relation to the fourth inner edge 34, between 75 degrees and 86 degrees at the intersection of the bottom edge 18 in relation to the fourth inner edge 34, between 75 degrees and 86 degrees at the intersection of the top edge 17 in relation to the fourth outer edge 24, between 75 degrees and 86 degrees at the intersection of the bottom edge 18 in relation to the fourth outer edge 24. While ranges of angles are provided here, it will be appreciated that all these stated angles should be the same angle for a dovetail joint, for example each may be 82 degrees. Thus, for a dovetail joint, the distance between the first inner guide and the second inner guide is greater than a distance between the first outer guide and the second outer guide.

Also shown in FIGS. 1 to 4, three end holes are located in a line along the end section, one of which is centered on the end section. Three side holes are found in the inner side section and the outer side section, one of which is centered between the first outer guide and the second outer guide and one of which is centered between the first inner guide and the second inner guide.

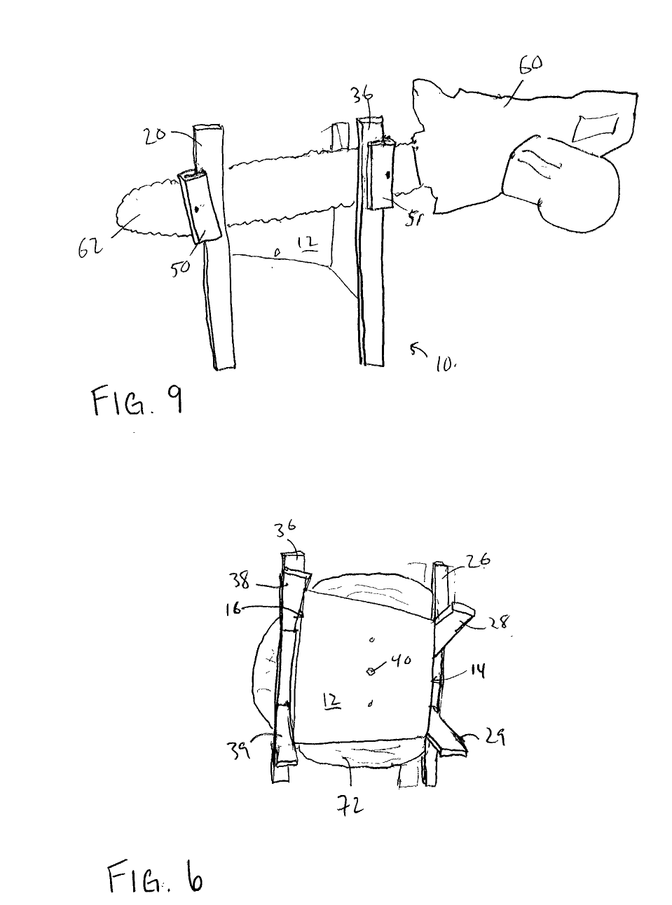

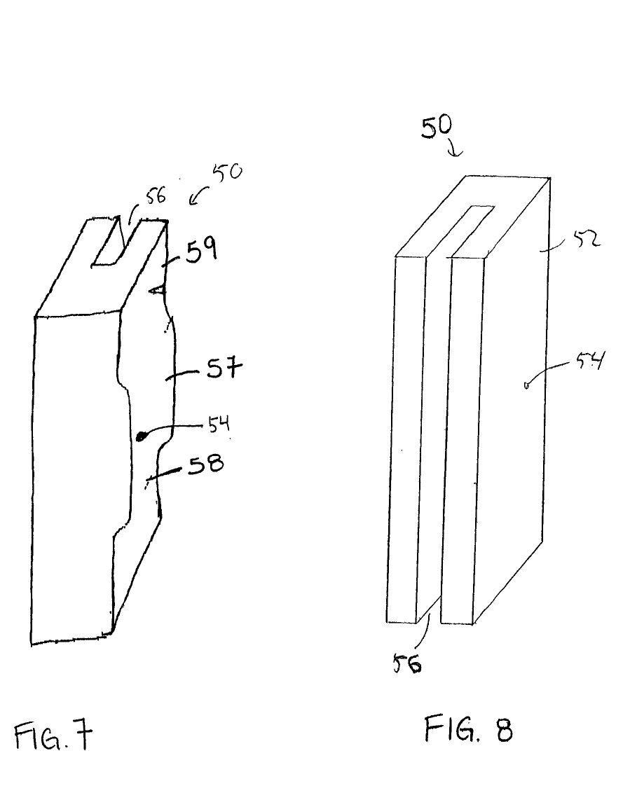

As shown in FIGS. 7 and 8, a slide 50 is provided for guiding a chainsaw. The slide 50 is a block 52 with an attachment channel 54 through the block 52. Attachment channel 54 is configured to receive a screw, pin, or other means to releasably secure the slide 50 to a chainsaw, such that raised portion 58 is against the chainsaw bar. A raised portion 58 creates set backs 58, 59. These set backs allow for the chain of a chain saw to move past the slide 50 without the chainsaw catching on the slide, which would damage the slides and/or influencing the cutting action in the wood. Thus raised portion 58 is effectively a spacer, without the need for a separate spacer, which would create opportunities for movement and thus inaccuracy. A slot 56 runs perpendicular to the attachment channel 54. The slot 56 is configured to receive a jig guide such as a jig guide of the present invention.

While the invention is shown in a preferred configuration, optimized for cutting dovetails, it will be appreciated the three sided jig of the invention can be readily adapted for use to cut other joint pieces. For example, all angles of the guides can be squared in relation to their adjacent guides, and the invention can be used to cut dado joints, such as through dadoes, stopped dadoes, rabbet joints, rabbet and dado joints, through tenons, blind tenons, and standard tenons. In other embodiments, a combination of dovetail angles and square angles can be used, to create a dovetail dado. One will also be able to readily adapt the invention to create non-symetrical joints. Many joints are directional; hence two different jigs can be configured to create the joints, each timber edge having an inside and an outside face. In other embodiments, the first and second guides can be adapted to include curves or angles to create stronger fits or more exotic designs. For such embodiments, a jig saw will be more appropriate than a chain saw, if there are short radius curves.

The jig can be made of stainless steel, aluminum, or any of various alloys known in the art. Alternatively, the jig can be injection molded using plastics. The finished jig can be painted or given a plastic coat.

In use, the holes are used to “sight in” and align the jig. As shown in FIG. 5, side holes 42 can be used to align the midline of the inner side section 30 (the midline being perpendicular to end section 12) with the midline of the log 70. As shown in FIG. 6, end holes 40 can be used to align the center of the rear section 12 with the center of the log 70. A screw or other releasable attachment means, such as a nail or pin, may then be placed in at least one hole, and preferably in one rear hole and one side section hole.

The bottom timber in a wall is only half height. For example, if constructing with 6″ wide×12″ tall timber, the bottom timber can only be 6″ tall. All three center holes are then used as sights and the higher holes are used for the anchoring screws. To cut the other end of the bottom timber, the jig is flipped upside down, and the then top holes are used for the anchoring screws.

As shown in FIG. 9, in use, the slides 50 and 51 are attached to the chainsaw 60, one slide near the proximal end of the chainsaw bar 62 and one near the distal end of the chainsaw bar 62. Each of the slides is held to the chainsaw bar at a single point. This single point attachment allows the chainsaw to cut deeper on one side than another, by angling the blade in relation to the guides. This is necessary when cutting shoulders on the timber.

The slides may be made of nylon, metal, wood, or any other material known in the art.

There are at least two methods for aligning the jig properly on the timber. Alignment of the jig is particularly important for compound dovetail cuts.

For the first method, the end face of the log or timber must be cut perpendicular to its length. The center of the end of the timber is found by drawing a line between opposite corners at the end of the log. The intersection of the lines marks the center, which can be aligned through the center end hole 40. Either end hole 40 and/or its adjacent holes can then be secured by use of a screw or other means to hold the jig steady.

The second method can be used for either a squared timber or round log. For a round log, the first few inches of the end of the log must be cut substantially straight, at substantially the width of the jig. A line, for example, a chalk line, is made lengthwise along the end of the timber or log to allow the jig to be lined up. The jig is then aligned with the lengthwise timber line using the side holes 42.

For cutting, a chainsaw with the slides installed is set on a pair of protruding guides. With the chainsaw cutting the wood, the slides follow the guide bars until they reach the end of their allowed travel, the slides being stopped by an alternate set of roughly perpendicular guides.

The cutting is repeated a total of four times using the three sets of guides, in any order: (1) the first outer guide 28 and first inner guide 38 are used to cut from the timber end 72 to the shoulder guides; (2) the second outer guide 29 and second inner guide 39 are used to cut from the timber end 72 to the shoulder guides; (3) the top shoulder guides 26, 36 are used to cut from the top of the timber to the outer and inner guides; and (4) the timber is rotated 180 degrees and step (3) is repeated. This cuts away two wedge shaped pieces, and leaves a compound dovetail on the timber. The jig is then removed for reuse.

When using the invention to create a compound dovetail joint, in order for the locking action of a compound dovetail to work most effectively, the wide side of the cut must be the “inside” of the joint.

It is to be understood that only the preferred embodiments have been shown, and that modifications thereof would be readily apparent to one skilled in the art. Therefore, the true scope and spirit of the invention resides in the appended claims and their legal equivalents, rather than by the given examples.

What I claim is:

1. A jig comprising:
a) a substantially planar end section having a top edge, a bottom edge, an outer portion and an inner portion, said inner portion located opposite said outer portion, and said top edge located opposite said bottom edge;
b) a substantially planar outer side section having a first outer edge, a second outer edge opposite the first outer edge, a third outer edge, and a fourth outer edge opposite the third outer edge, wherein said outer side section is fixed to said outer portion of said end section at said fourth outer edge, and said outer side section is substantially perpendicular to said end section;
c) a substantially planar inner side section having a first inner edge, a second inner edge opposite the first inner edge, a third inner edge, and a fourth inner edge opposite the third inner edge, wherein said inner side section is fixed to said inner portion of said end section at said fourth inner edge, and said inner side section is substantially perpendicular to said end section;
d) a first outer guide fixed to and extending along said first outer edge;
e) a second outer guide fixed to and extending along said second outer edge;
f) a shoulder outer guide fixed to and extending along said third outer edge;
g) a first inner guide fixed to and extending along said first inner edge;
h) a second inner guide fixed to and extending along said second inner edge; and
i) a shoulder inner guide fixed to and extending along said third inner edge.

2. A jig as claimed in claim 1, wherein said inner side section and said outer side section are quadrilateral.

3. A jig as claimed in claim 2, wherein said third inner edge is parallel to said fourth inner edge and said third outer edge is parallel to said fourth outer edge.

4. A jig as claimed in claim 3, wherein said first inner edge is parallel to said second inner edge and said first outer edge is parallel to said second outer edge.

5. A jig as claimed in claim 3, wherein said first inner guide, said second inner guide, said first outer guide, and said second outer guide are straight.

6. A jig as claimed in claim 5, wherein said first inner guide and said second inner guide are each fixed at an acute angle in relation to said fourth inner edge, and first outer guide and said second outer guide are each fixed at an acute angle in relation to said fourth outer edge.

7. A jig as claimed in claim 6, wherein a distance between said first inner guide and said second inner guide is greater than a distance between said first outer guide and said second outer guide.

8. A jig as claimed in claim 1, further comprising an end hole in said end section.

9. A jig as claimed in claim 8, wherein said end hole is centered on said end section.

10. A jig as claimed in claim 1, further comprising a side hole in at least one of said inner side section and said outer side section.

11. A jig as claimed in claim 10, wherein said side hole is on a midline between said first outer guide and said second outer guide and/or on a midline between said first inner guide and said second inner guide.

12. A jig as claimed in claim 3, wherein angles at an intersection of the second inner guide in relation to the fourth inner edge, at an intersection of the first inner guide in relation to the fourth inner edge, at an intersection of the second outer guide and the fourth outer edge, at an intersection of first outer guide in relation to the fourth outer edge, at an intersection of the second inner guide in relation to the shoulder guide, at an intersection of the first inner guide in relation to the shoulder guide, at an intersection of the second outer guide in relation to shoulder guide, at an intersection of the first outer guide in relation to the shoulder guide, at an intersection of the top edge in relation to the fourth inner edge, at an intersection of the bottom edge in relation to the fourth inner edge, at an intersection of the top edge in relation to the fourth outer edge, and at an intersection of the bottom edge in relation to the fourth outer edge, are all between 75 degrees and 86 degrees, all stated angles are the same, and said jig is configured such that third outer edge is shorter than said fourth outer edge, said third inner edge is shorter than said fourth inner edge, and said fourth outer edge is shorter than said fourth inner edge.

13. A slide for guiding a chainsaw comprising a block having a chainsaw side and an outer side, an attachment channel through the block and a slot running perpendicular to said slide channel, said slot configured to receive a jig guide, and a spacer portion on said chain saw side.

14. A slide as claimed in claim 13, wherein said jig guide is a guide of the jig of claim 1.

15. In combination, a slide of claim 13 and a chainsaw.

16. In combination, a slide of claim 13 and a jig.

17. The combination as claimed in claim 16, wherein the jig is the jig as claimed in claim 1.

18. A method of cutting a joint on a length of timber comprising:
a) cutting a timber end of said timber so that it is substantially same width as a distance between the outer shoulder guide and the inner shoulder guide of said jig of claim 1;
b) cutting said timber end to form an end face perpendicular to the length of the timber;
c) releasably securing said jig on said timber so that the end section is substantially flat against said end face and so that said end section is substantially centered on said timber end; and
d) cutting said timber end along said first inner guide and said first outer guide, cutting said timber end along said second inner guide and said second outer guide and, cutting said timber end along said inner shoulder guide and said outer shoulder guide.

19. A method of cutting a joint on a length of timber comprising:
a) cutting a timber end of said timber so that it is substantially same width as a distance between the outer shoulder guide and the inner shoulder guide of said jig of claim 1;
b) marking a timber line parallel to said length of timber;
c) releasably securing said jig on said timber so that a midline of said outer side section and a midline of said inner side section is substantially parallel to said timber line, said midline extending substantially perpendicular to said end section; and
d) cutting said timber end along said first inner guide and said first outer guide, cutting said timber end along said second inner guide and said second outer guide and, cutting said timber end along said inner shoulder guide and said outer shoulder guide.

20. A jig comprising:
an end panel;
two side panels attached at opposite sides of said end panel, each said side panel perpendicular to the end panel;
shoulder guides attached to each said side panel at a portion of said side panels opposite said end panel, said shoulder guides extending beyond the side panels; and
joint guides attached to each side panel, said joint guides running between said end panel and said shoulder guides.
